(19) United States
(12) Patent Application Publication
(10) Pub. No.: US 2009/0075232 A1
(43) Pub. Date: Mar. 19, 2009

(54) COUPLING SYSTEM FOR HAND INSTRUMENTS FOR DENTAL OR SURGICAL USE

(75) Inventor: Luc Maitre, Epauvillers (CH)

Correspondence Address: YOUNG & THOMPSON, 209 Madison Street, Suite 500, ALEXANDRIA, VA, 22314, US

(73) Assignee: BIEN-AIR HOLDING SA, Bienne (CH)

(21) Appl. No.: 12/293,279

(22) PCT Filed: Jun. 21, 2007
(86) PCT No.: PCT/EP07/56170

§ 371 Date: Sep. 17, 2008

(30) Foreign Application Priority Data
Jul. 18, 2006 (EP) 06117350.6

(51) Int. Cl. A61C 3/00

(52) U.S. Cl. 433/127

(57) ABSTRACT

A coupling system for shafts of the lower gripper mechanism and the upper motor mechanism of an instrument includes: —a hollow shaft whose upper end can couple to the lower end of the motor mechanism shaft and whose lower end can slide around the upper end of the gripper mechanism shaft; a movable pin connecting the lower end of the hollow shaft with the upper end of the gripper mechanism shaft; a spring; two diametrically opposed oblong windows serving to limit the path of the pin such that, for the hollow shaft and the gripper mechanism shaft, a first relative position wherein they are separated maximally and a second relative position wherein they are approached maximally are defined; and a holder whose length is such that, only in the second position, it allows the pin to appear allowing connection separation of the coupling system and the gripper mechanism, respectively.

The present invention relates to the field of medical instruments. It more particularly concerns a coupling system for a hand-held instrument designed to rotate, at a high speed, a detachable tool whereof the end constitutes a bur or similar member usable in dental offices or laboratories as well as in microsurgery.

One instrument of this type is described, for example, in document WO 2005/089666. Typically, the shank of the tool is held by a gripper arranged inside a hollow rotating shaft driven at its end by an electric motor or an air turbine and mounted by bearings in a fixed tubular sheath. Gripping and releasing of the gripper is done by turning a sleeve mounted to rotate on the shaft in one direction or the other.

An instrument of this type is generally made in three parts, i.e. a gripper mechanism with its output and input shafts for fixing of the instrument, a motor mechanism to drive the gripper mechanism in rotation, and a system for coupling the gripper mechanism with the motor mechanism.

These three components must be able to be easily separated from each other in order to allow the same motor mechanism to actuate different types of gripper mechanisms and authorize the replacement of the coupling system subjected to stresses which accelerate its wear.

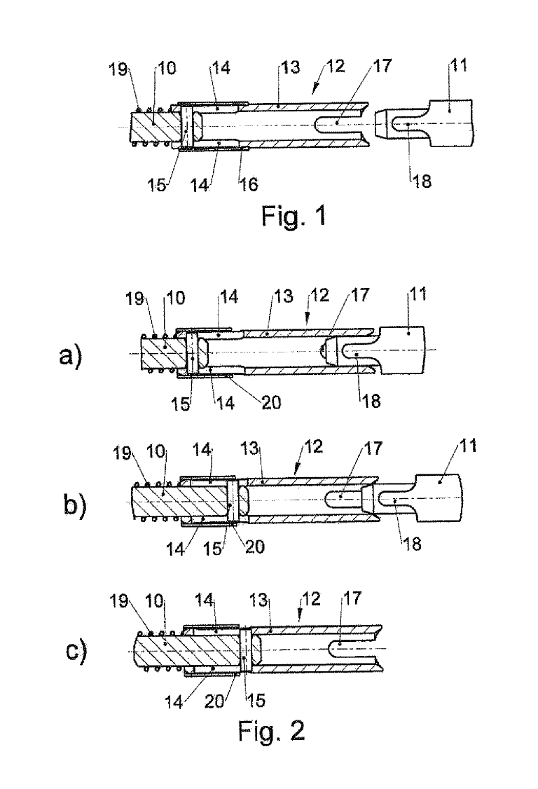

We will first refer to FIG. 1, which shows, in an embodiment of the prior art, the way in which the three components are assembled. In order to facilitate reading, the present description will use the words “upper” and “lower” to designate the end of the instrument from which the tool is driven in rotation (right part of the figure) and its end bearing the operative tip of the tool (left part of the figure), respectively. Furthermore, the drawing does not show the upper and lower parts of the instrument because these parts may be identical to those described in the aforementioned WO 2005/089666, to which one may refer to understand the way in which the tool is driven.

In FIG. 1, we have shown in 10 the upper end of the input shaft of the gripper mechanism, in 11 the lower end of the shaft of the motor mechanism, and in 12 the coupling system according to the invention.

This system 12 comprises a hollow shaft 13 provided, at its lower end, with two diametrically opposed oblong axial windows 14. The upper end 10 of the shaft of the gripper mechanism is slidingly mounted in the lower end of the shaft 13 and passed through by a movable connecting pin 15 the path of which is limited axially by the two windows 14. A slotted holder 16, clipped around the portion of the shaft 13 which comprises these windows, holds the pin 15 in place. To separate the input shaft of the gripper mechanism from the coupling system, it is therefore necessary to unclip the holder 16 in order to expose the pin 15 which can then be removed, thereby making it possible to separate the shafts 10 and 13.

The upper end of the shaft 13 is provided with two diametrically opposed oblong axial notches 17 (only one of which appears in the drawing) which are sized and adapted so as to receive two fins 18 (only one of which appears in the drawing) which terminate the shaft 11 of the motor mechanism. According to one embodiment, the number of pairs of diametrically opposed notches may be greater, in order to facilitate insertion of the fins 18.

Lastly, one will note the presence of a spring 19 which is arranged around the shaft 10 and pushes the shaft 13 upward. Thanks to this spring, even if the practitioner did not take care to stop the motor, the shaft 13 still has the possibility of retracting itself more or less in order to facilitate the connection of the motor mechanism to the coupling system.

Although this type of method for connecting the motor mechanism to the coupling system is fully satisfactory, the same is not true of the connection between the coupling system and the input shaft of the gripper mechanism. Indeed, the solution described above uses a fairly complex holder which is not easy to produce and the assembly or disassembly of which requires a special tool. Moreover, this clipped slotted holder does not ensure holding able to resist a connection when the motor is still in rotation.

The present invention aims in particular to provide a coupling system free from the abovementioned drawbacks.

More precisely, the invention concerns a coupling system for the shafts of the lower gripper mechanism and the upper motor mechanism of a hand instrument for dental or surgical use, characterized in that it comprises:
a hollow shaft whereof the upper end is adapted for being coupled to the lower end of the motor mechanism shaft and the lower end of which can slide around the upper end of the gripper mechanism shaft,
a movable pin connecting the lower end of the hollow shaft with the upper end of the gripper mechanism shaft,
a spring tending to separate the hollow shaft from the gripper mechanism shaft,
two diametrically opposed oblong windows performed axially within the lower end of the hollow shaft and serving for limitation of the path of the pin such that, for the hollow shaft and the gripper mechanism shaft, a first relative position wherein the hollow shaft and the gripper mechanism shaft are separated maximally and a second relative position wherein they are approached maximally are defined, and
a holder disposed on the lower end of the hollow shaft and the length of which is such that, only in said second position, it allows the pin to appear in order to permit its insertion or its extraction allowing for the connection or the separation of the coupling system and the gripper mechanism, respectively.

Other characteristics and advantages of the present invention will be shown by the following description, done with regard to the appended drawing in which FIG. 2 is a longitudinal cross-section of one such coupling system, the elements shared by FIG. 1 illustrating the prior art being designated by the same reference numbers.

FIG. 2 shows, in a, b and c, respectively, the system according to the invention:
in a first extreme position, for which the upper end 10 of the gripper mechanism shaft is the least engaged in the hollow shaft 13;
in an intermediate position, during connection of a motor; and
in a second extreme position, for which the upper end 10 of the gripper mechanism shaft is the most engaged in the hollow shaft 13.

The system from FIG. 2 presents two essential differences in relation to the system of FIG. 1.

First, the detachable holder 16 is replaced by an irremovable holder 20 advantageously fixed by countersinking on the lower end of the hollow shaft 13.

Secondly, this irremovable holder 20 does not completely close the two oblong openings 14. Its length is such that:
in the first extreme position (FIG. 2a), assumed automatically, under the action of the spring 19, when the instrument is at rest or at work, it covers the pin 15;
in the intermediate position (FIG. 2b), normally assumed under the effect of the downward force exerted during connection of a motor, it also covers the pin 15 and thereby does not risk escaping,
in the second extreme position (FIG. 2c), assumed during connection or disconnection with the gripper mechanism and requiring that the operator exerts a downward push substantially stronger than in the case of a simple connection of the motor, it allows the pin 15 to appear in order to authorize its insertion or its extraction, which makes it possible to connect or separate the coupling system and the gripper mechanism, respectively.

Thus is proposed a coupling system which greatly facilitates assembly and disassembly operations. It is then sufficient, in fact, for the operator simply to manually push the hollow tube 13 as far downward as possible, while working against the spring 19, to expose the pin 15 which can be inserted or withdrawn. One will also note that holding of the holder 20 resists a connection better than a simply clipped slotted holder when the motor is still in rotation. One will lastly note that the holder 20 is a simple tube whereof the production is made significantly easier relative to that of the clipped slotted pin of the prior art.

1-2. (canceled)

3. A coupling system for the shafts of the lower gripper mechanism and the upper motor mechanism of a hand instrument for dental or surgical use, wherein it comprises:
a hollow shaft the upper end of which is adapted for being coupled to the lower end of the motor mechanism shaft and the lower end of which can slide around the upper end of the gripper mechanism shaft,
a movable pin connecting the lower end of the hollow shaft with the upper end of the gripper mechanism shaft,
a spring tending to separate the hollow shaft from the gripper mechanism,
two diametrically opposed oblong windows performed axially within the lower end of the hollow shaft and serving for limitation of the path of the pin such that, for the hollow shaft and the gripper mechanism shaft, a first relative position wherein they are separated maximally and a second relative position wherein they are approached maximally are defined, and
a holder disposed on the lower end of the hollow shaft and the length of which is such that, only in said second position, it allows the pin to appear in order to permit its insertion or its extraction allowing for the connection or the separation of the coupling system and the gripper mechanism, respectively.

4. The coupling system according to claim 3, designed for a motor mechanism shaft terminated by at least one fin, wherein the upper end of said hollow shaft is provided with oblong notches which are sized and adapted so as to receive said fin.
